(19) United States
(12) Patent Application Publication
(10) Pub. No.: US 2006/0219482 A1
(43) Pub. Date: Oct. 5, 2006

(54) Relief valve for a grease gun

(76) Inventor: Tien-Chen Tung, Taipei City (TW)

Correspondence Address: BRUCE H. TROXELL, SUITE 1404, 5205 LEESBURG PIKE, FALLS CHURCH, VA, 22041, US

(21) Appl. No.: 11/128,254

(22) Filed: May 13, 2005

(30) Foreign Application Priority Data
Mar. 17, 2005 (TW) 094204145

(51) Int. Cl. F16N 21/00

(52) U.S. Cl. 184/105.2

(57) ABSTRACT

A grease gun includes a relief valve and a grease barrel. The relief valve has a main member associated with the grease barrel. The main member further includes a compression passage with a relief outlet and a first opening, a first passage communicating the with compression passage at one end thereof and being joined to the barrel opening with the another end thereof, a second passage communicating with the relief outlet at one end thereof and having a second opening communicating with outside of the main member for receiving a ball, an elastic element and a screw rod and a third passage communicating with the second passage at one end thereof and joining the barrel opening at another end thereof. Once the screw rod is adjusted the length thereof in the second passage for regulating compression amount of the elastic element, the force of the ball for blocking the relief outlet is capable of being controlled.

### BACKGROUND OF THE INVENTION

1. Field of the Invention

The present invention is related to a grease gun for the grease being injected into a machine or apparatus and particularly to a relief valve for an electric or pneumatic grease gun.

2. Brief Description of Related Art

Patents such as U.S. Pat. No. 5,779,05, U.S. Pat. No. 4,219,131 and U.S. Pat. No. 4,063,618, U.S. Pat. No. 4,062,425 disclose a grease gun with a relief device. However, the preceding US patents do not disclose structure with regard to grease being moving back the grease barrel. It is known that it is wasteful to discharge the grease outside the grease gun with the relief device and it pollutes the environment and makes dirty to the user if the discharged grease is left outside.

Referring to FIG. 1, Issue No. 242941 of Taiwanese Patent Official Gazette discloses an electric grease gun, which provides a feature that an automatic relief outlet 32 is located near the outer opening of the compression passage 31 at the cover 3 on the grease barrel 2. A ball 33 is disposed in the relief outlet 32 with being biased by a spring 34. Due to the relief outlet 32, grease with excessive pressure is pushed back to the grease barrel 2 to secure the grease gun 1 being not damaged.

The preceding grease gun disclosed in the Taiwanese patent Issue No. 242941 provides a fixed relief pressure, which it is incapable of being adjusted in accordance with actual need, although the function of grease discharging back the grease barrel can be performed. That is, the grease has to be moved back the grease barrel once the pressure of the grease exceeds the fixed pressure in spite of the grease being not filled with the compression passage. As a result, it is inconvenient while in use.

### SUMMARY OF THE INVENTION

An object of the present invention is to provide a relief valve for a grease gun with which the relief pressure can be adjusted based on need.

Another object of the present invention is to provide a relief valve with which the relief pressure can be adjusted conveniently for broadening the application thereof.

### BRIEF DESCRIPTION OF THE DRAWINGS

The present invention can be more fully understood by reference to the following description and accompanying drawings, in which:

FIG. 1 is a plan view of a conventional relief valve for a grease gun;

FIG. 2 is a plan view of a relief valve for a grease gun according to the present invention;

FIG. 3 is a plan view illustrating the relief valve of the present invention being in a state prior to pressure relief;

FIG. 4 is a plan view illustrating the relief valve of the present invention being in a state of pressure relief; and

FIG. 5 is a plan view of another embodiment of a relief valve for a grease gun according to the present invention.

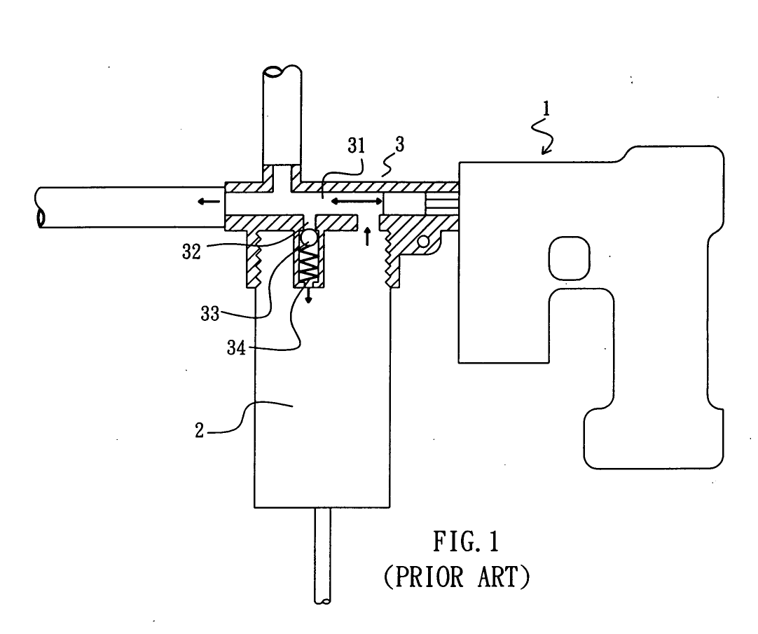

### DETAILED DESCRIPTION OF THE INVENTION

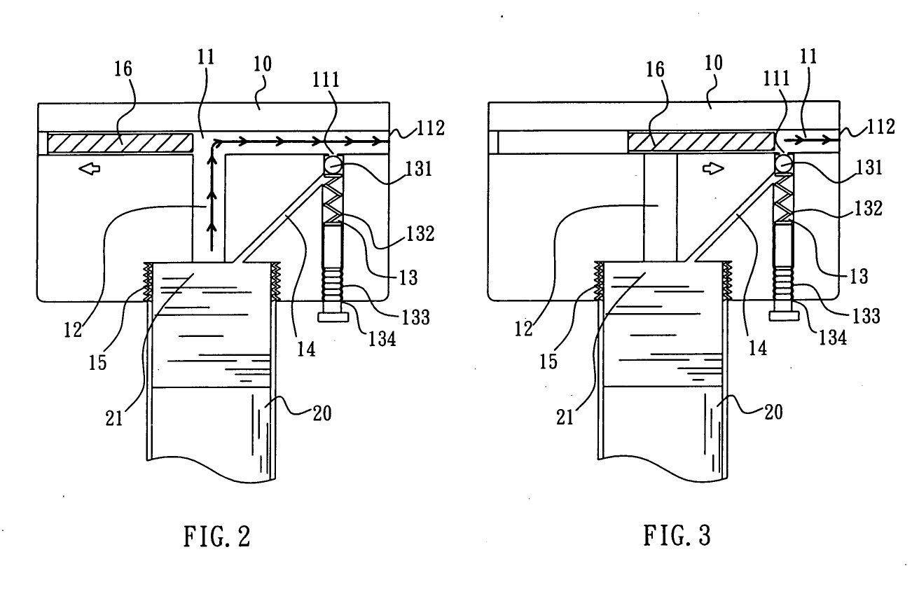

Referring to FIGS. 2, 3 and 5, a relief valve for a grease gun according to the present invention includes a main member 10 with a compression passage 11, a first passage 12, a second passage 13, a third passage 14 and an opening 15 associated with a grease barrel 20. The compression passage 11 has a relief outlet 111 and an external opening 112 communicating with the main member 10. A plunger 16 is received in the compression passage 11. The relief outlet 111 is disposed near the external opening 112. The first passage 12 communicates with the compression passage 11 and the opening 15 at both ends thereof respectively. The second passage 13 has a relief outlet 111 at an end thereof to communicate with the compression passage 11 and has an external opening 134 at another end thereof at the bottom of the main member 10. The second passage 13 receives a ball 131 and an elastic element 132 and engages with a screw rod 133. The screw rod 133 has a head end extends outward the external opening 134. Alternatively, an end of the screw rod 133 is in the second passage 13 instead of the head end as shown in FIG. 5. The screw rod 133 biases an end of the elastic element 132 at another end thereof and the other end of the elastic element 132 biases the ball 131 such that the ball 131 can block the relief outlet 111 with a force. The third passage 14 communicates with the second passage 13 and the opening 15 at both ends thereof respectively.

The opening 15 is joined to an opening 21 of the grease barrel 20. When the plunger 16 moves leftward along the direction of the arrow shown in FIG. 2, the grease in the grease barrel 20 enters the compression passage 11 via the first passage 12. When the plunger 16 moves rightward along the direction of the arrow shown in FIG. 3, the grease in the compression passage 11 is pushed to discharge via the opening 112.

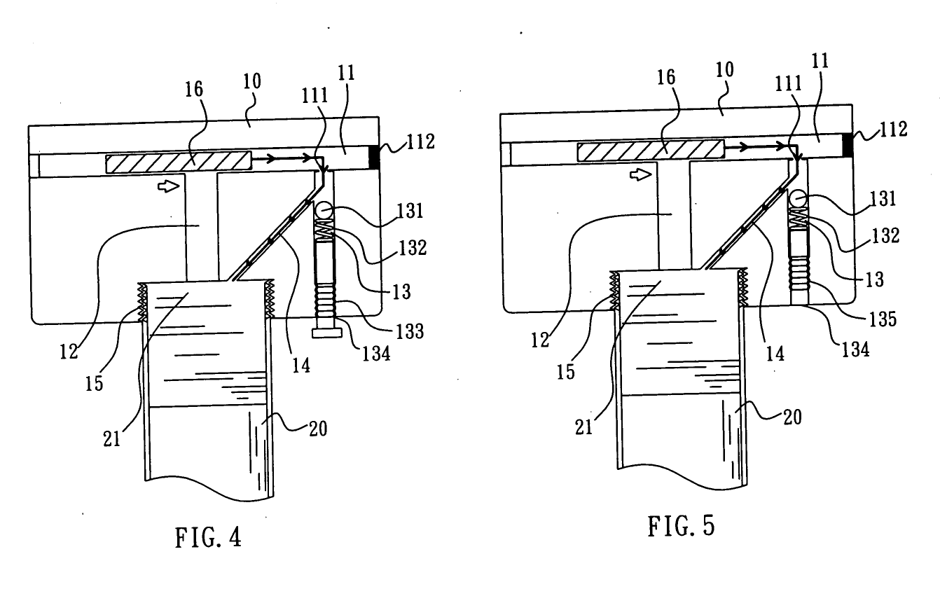

Referring to FIG. 4, in case of the compression passage being full with the grease and incapable of discharging via the opening 112, pressure at relief outlet 111 is greater than the force of the elastic element 132 biasing the ball 131 and the grease pushes the ball 131 away the block position such that the grease moves back to the grease barrel 20 via the third passage 14. In this way, the grease gun would not be hurt by pressure rise in compression passage 11.

The screw rod 133 can be turned with a screw driver or fingers to adjust the length thereof in the second passage 13 so such the compression amount of the elastic element 132 is regulated to control the force of the ball 131 blocking the relief outlet 111 for meeting different pressure requirements of grease injections. Due to the screw rod 133 providing a head end extending outward the main member, it is convenient for the user regulating relief pressure.

While the invention has been described with referencing to preferred embodiments thereof, it is to be understood that modifications or variations may be easily made without departing from the spirit of this invention, which is defined by the appended claims.

What is claimed is:

1. A relief valve for a grease gun, comprising:
a main member; and
a grease barrel with a barrel opening, being associated with the main member;
wherein, the main member further comprises:
a compression passage, having a relief outlet and a first opening communicating outside the main member and near the relief outlet, receiving a plunger, which slidably moves back and forth;
a first passage with two ends, communicating the with compression passage at one of the ends and being joined to the barrel opening with the other one of the ends;
a second passage with two ends, communicating with the relief outlet at one of the ends thereof and having a second opening communicating with outsides of the main member, receiving a ball, which is biased by an end of an elastic element, engaging with a screw rod, which presses against another end of the elastic element, for the ball having a force to maintain a state of blocking the relief outlet; and
a third passage with two ends, communicating with the second passage at one of the ends and joining the barrel opening at the other one of the ends;
whereby, once the screw rod is adjusted the length thereof in the second passage for regulating compression amount of the elastic element, the force of the ball for blocking the relief outlet is capable of being controlled.

2. The relief valve for a grease gun as defined in claim 1, wherein the screw rod has a head end extending outward the second passage.
